(19) United States
(12) Patent Application Publication
(10) Pub. No.: US 2002/0149852 A1
(43) Pub. Date: Oct. 17, 2002

(54) Projection systems

(76) Inventors: Michael Dubinovsky, Pembroke Pines, FL (US); Douglas A. Kirkpatrick, Great Falls, VA (US); Bruce Shanks, Sioux Falls, SD (US); Paul E. Steiner, Olney, MD (US); Brian P. Turner, Germantown, MD (US)

Correspondence Address: FUSION LIGHTING INC, PAUL E STEINER, 7524 STANDISH PLACE, ROCKVILLE, MD, 20855

(21) Appl. No.: 10/120,792

(22) Filed: Apr. 12, 2002

Related U.S. Application Data
(60) Provisional application No. 60/283,341, filed on Apr. 13, 2001.

(51) Int. Cl. G02B 27/10; G02B 27/14

(52) U.S. Cl. 359/618; 359/629

(57) ABSTRACT

Various projection systems are described with improved performance. A projection system utilizes negative distortion together with a pre-compensated light source to reduce spill. A projection system utilizes a single angle transforming optical element positioned between an imager and a light source to increase throughput. A two panel projection system utilizes both polarities to increase light output. A projection system utilizes a three segment color wheel with a small white bias in each segment to reduce color breakup. A projection system utilizes a digital micro-mirror device and recycles OFF state light. A projection system utilizes two color wheels to improve recycling of light. A two panel projection system utilizes a color wheel which transmits a deficient color band and time sequences the other bands while reflecting the unused light back to the light source for recycling.

### CROSS REFERENCE TO RELATED APPLICATIONS

This application is based on and claims priority to U.S. Provisional Patent Application No. 60/283,341, filed Apr. 13, 2001.

This application is related to a provisional patent application No. 60/256,350, entitled “DISCHARGE LAMP WITH INDIUM AND ERBIUM FILL”, filed on Dec. 19, 2000; No. 60/256,353, entitled “TWO PANEL PROJECTION SYSTEM”, filed on Dec. 19, 2000; No. 60/255,378, entitled “PROJECTION SYSTEM UTILIZING ASYMMETRIC ETENDUE”, filed on Dec. 15, 2000; and No. 60/263,520, entitled “PROJECTION SYSTEM UTILIZING ASYMMETRIC ETENDUE”, filed on Jan. 24, 2001, each of which is incorporated by reference in its entirety.

### BACKGROUND

Field of the Invention

The invention relates generally to projection systems and more specifically to projection display systems.

### SUMMARY

The following and other objects, aspects, advantages, and/or features of the invention described herein are achieved individually and in combination. The invention should not be construed as requiring two or more of such features unless expressly recited in a particular claim.

An object of the inventions described below is to improve the performance of a projection system.

### BRIEF DESCRIPTION OF THE DRAWINGS

The foregoing and other objects, features, and advantages of the invention will be apparent from the following more particular description of preferred embodiments as illustrated in the accompanying drawings, in which reference characters generally refer to the same parts throughout the various views. The drawings are not necessarily to scale, the emphasis instead being placed upon illustrating the principles of the invention.

FIG. 1 is a schematic diagram of a projection system utilizing negative distortion.

FIG. 2 is a schematic diagram of a projection system utilizing negative distortion together with a pre-compensated light source.

FIG. 3 is a schematic diagram of a projection system utilizing negative distortion and anamorphic optics together with a pre-compensated light source.

FIG. 4 is a schematic diagram of a projection system with only a single optic between the light source and the image gate.

FIG. 5 is a perspective view of an optic with a remote aperture.

FIG. 6 is a perspective view of a segmented optic.

FIG. 7 is a schematic diagram of a dual panel projection system utilizing 15 both polarities.

FIG. 8 is a schematic diagram of a four segment color wheel, including a white segment.

FIG. 9 is a schematic diagram of a three segment color wheel with a distributed white bias.

FIG. 10 is a schematic diagram of a projection system adapted to recycle OFF state light.

FIG. 11 is a schematic diagram of a two color wheel projection adapted to recycle time sequenced colors.

FIG. 12 is a schematic diagram of a dual panel projection system adapted to recycle time sequenced colors.

### DESCRIPTION

In the following description, for purposes of explanation and not limitation, specific details are set forth such as particular structures, interfaces, techniques, etc. in order to provide a thorough understanding of the various aspects of the invention. However, it will be apparent to those skilled in the art having the benefit of the present disclosure that the various aspects of the invention may be practiced in other examples that depart from these specific details. In certain instances, descriptions of well known devices, circuits, and methods are omitted so as not to obscure the description of the present invention with unnecessary detail.

Pre-Distorted Aperture for Negative Distortion Optical System

A problem with collection optics is a tendency for illumination to roll-off at the edges of the projected image. Even with an ideal system there is a cosine to the fourth power roll-off factor.

The aperture lamps described in U.S. Pat. Nos. 5,903,091 and 6,137,237 and PCT Publication No. WO 01/03161 provide relatively good uniformity at the bulb aperture. The remote aperture lamps described in PCT Application No. PCT/US00/26246 provide good uniformity at the remote aperture. According to a present aspect of the invention, an optical system utilizes negative distortion and/or comma to maintain uniformity at the image gate.

In a negative distortion system, there is a smaller magnification factor at the edges as compared to the center. The smaller magnification at the edges results in higher illumination at the edges of the image gate, neglecting losses. Even taking losses into account, the illumination is better at the edges as compared to a system with no negative distortion. With reference to FIG. 1, a rectangular shaped light source 11 is directed through an optical system 13 having negative distortion. The resulting projected image 15 has a pin cushion shape which overfills a target 17. For example, the target corresponds to a light valve in a projection system (e.g. an LCD or a DMD).

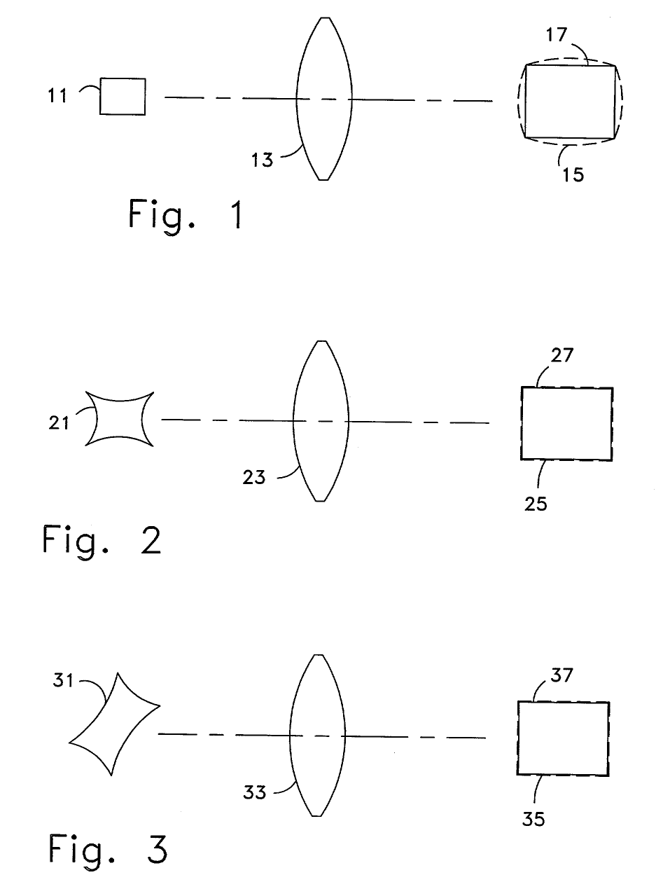

According to one aspect of the invention, the shape of the light source is pre-compensated for the negative distortion (e.g. to counteract the pin cushion effect). With reference to FIG. 2, a light source 21 has a shape which is pre-compensated in accordance with the negative distortion of an optical system 23 such than a resulting projected image 25 substantially corresponds to a target image 27 with minimal spill. With the pre-compensated shape of the source 21, the target is not overfilled (or is overfilled to a lesser degree) and less light is wasted. For example, the pre-compensated light source 21 may be provided by a shaped aperture on the bulb or by a shaped remote aperture. In this example, the aperture or source 21 has the general shape of an inverted pin cushion (a rectangle with pinched corners). However, the source 21 may take other shapes in accordance with the nature and degree of distortion provided by the optical system 23. For a particular optical system, the pre-compensated shape may be determined mathematically or by ray tracing the target back through the optical system to a source plane.

The above-mentioned '378 application describes a projection system using anamorphic optics together with a pre-compensated aperture. The projection system of FIG. 2 may be combined with anamorphic optics to increase system throughput together with an aperture shape pre-compensated for both the negative distortion and the anamorphic optics. With reference to FIG. 3, a light source 31 has a shape which is pre-compensated in accordance with both the negative distortion and anamorphic optics of an optical system 33 such than a resulting projected image 35 substantially corresponds to a target image 37 with minimal spill. For example, the pre-compensated light source 31 may be provided by a shaped aperture on the bulb or by a shaped remote aperture.

Single Angle Transforming Optic Projection System

An image gate will utilize light within a given etendue. A preferred light source provides sufficient light within the image gate's etendue with acceptable uniformity. Each optical element in the projection train can at best preserve etendue and generally decreases the throughput. With the present invention, the image gate is positioned as close to the light source as practical to increase throughput.

For light with a given source angular distribution, a CPC can be designed to transform the source distribution to a tighter distribution (e.g. meeting the image gate's etendue requirement). If the light output from the CPC is sufficiently uniform, no further optical elements are needed to illuminate the gate. As noted above, light output from certain aperture lamps is relatively uniform and may provide sufficient uniformity to reduce the number of further optical elements in the projection train.

According to a present aspect of the invention, only a single angle transforming optical element is positioned between an imager and a light source.

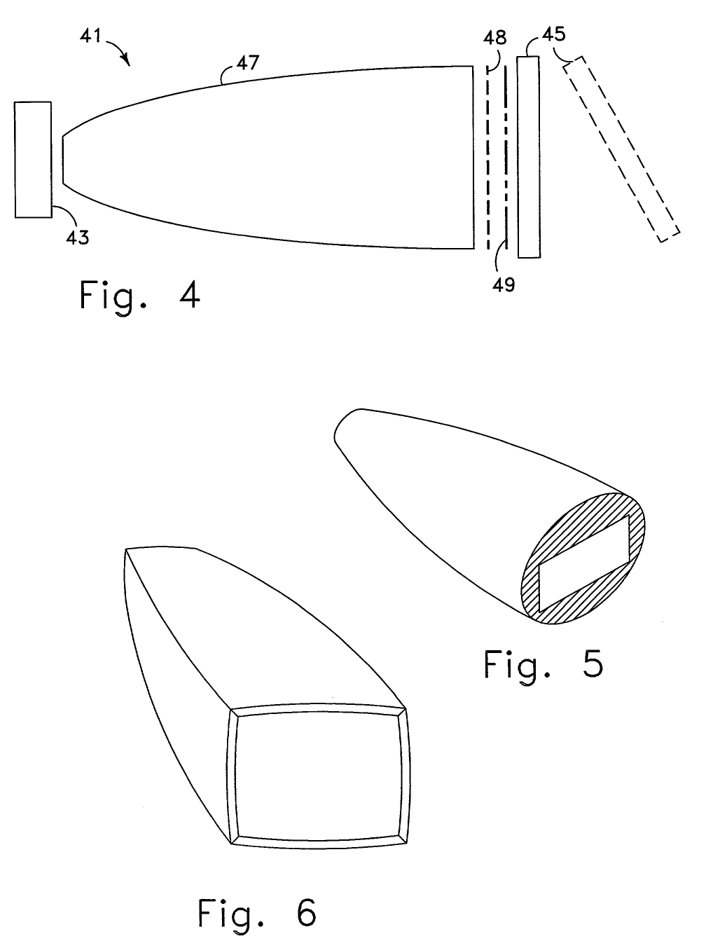

With reference to FIG. 4, a projection system 41 includes a light source 43 and an imager 45 with only a single angle transforming optical element 47 positioned between the light source 43 and the imager 45. The angle transforming optical element 47 is adapted to transform light from the angle presented by the source 43 to an angle acceptable to the imager 45. For example, an aperture lamp may be adapted to provide light with an angular distribution of 70° half angle and an imager may have an acceptance angle of 12° half angle. A compound parabolic concentrator (CPC) may readily be designed to accomplish the desired angular transformation for the given aperture size and image gate size.

The imager 45 may be reflective or transmissive. If transmissive, the imager 45 is positioned parallel to the output end of the optical element 47. If reflective, the imager 45 is angled relative to the output end of the optical element 47 (e.g. dashed line imager 45). If necessary or desirable filters 48, 49 may be used in the projection system 41. For example, such filters may be used to polarize the light, to filter UV and/or IR, and/or to time sequence colors on the imager. Light from the imager may then be collected by a projection lens system (not shown) and projected onto a screen.

With reference to FIG. 5, the optical element may comprise a CPC with a remote aperture. With reference to FIG. 6, the optical element may comprise a segmented CPC. Both of the foregoing are described in more detail in PCT Application No. PCT/US00/26246, which is herein incorporated by reference in its entirety.

Dual Imager Projection System Utilizing Both Polarities

In a three color display system, a projection engine may use one, two or three imaging devices (also referred to herein as “panels”). With a three panel system, the light is split into three colors by suitable optics and filters and each color is directed to a separate imager. Total light output is high, but it is difficult to maintain alignment of the three panels and cost is high because three relatively costly imaging devices and corresponding optics are required for each color.

Color sequential projection systems are well known in the art. In a one panel system, light from a light source is time multiplexed into three or more sequential colors (e.g. red, green, and blue) by a rotating color wheel or color shutters. The color sequential light is directed to a single imaging device which modulates the light with individual pixel elements which are synchronized with the color scheme. For example, pixels corresponding to the red portion of an image are actuated when the red portion of the color sequential light is on the imager. The one panel system is less expensive and requires no alignment, but the light output is lower because only a fraction (e.g. one third) of the available light is imaged onto the screen.

A two panel system is a compromise between the cost and alignment problems of the three panel system and the lower light of the one panel system. In conventional two panel projection systems, light is split along two optical paths with one color or set of colors going along each path. As compared to the three panel system, the two panel system is easier to align, but has lower light output. As compared to the single panel system, the two panel requires some alignment but has higher light output because a greater fraction of the light is utilized at one time.

With conventional one, two, or three panel systems, however, many LCD imagers throw away half of the light because they require polarized light. Some systems try to re-use the polarized light with a P/S combiner, but this doubles the etendue and requires a larger imager. In accordance with a present aspect of the invention, a two panel projection system utilizes both polarities without increasing the etendue.

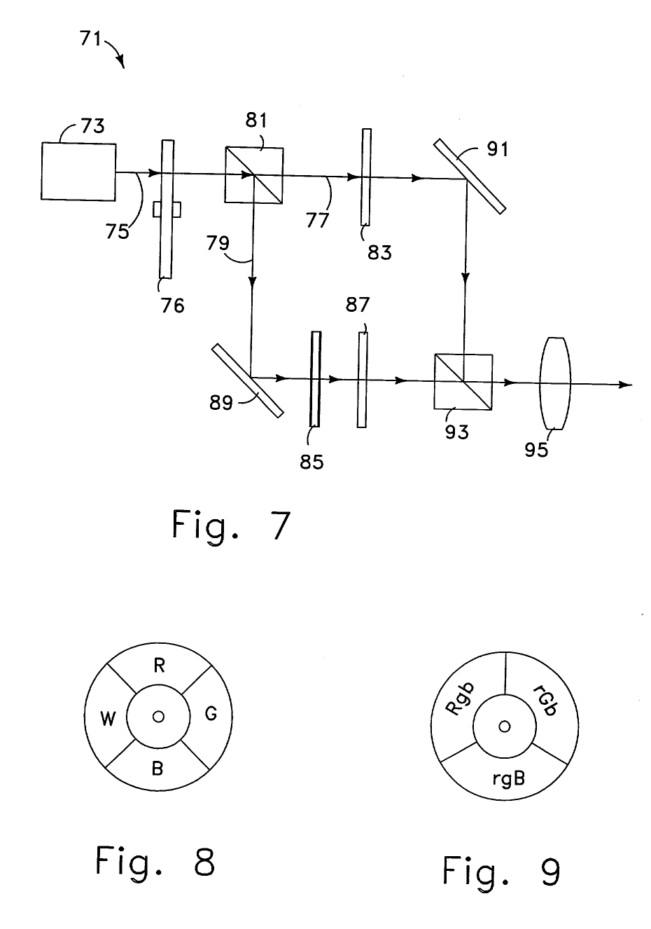

With reference to FIG. 7, a projection system 71 includes a lamp 73 which preferably provides full spectrum light. The light 75 from the lamp 73 is time sequenced into color segments by a color wheel 76 and split into two polarities along a first optical path 77 and a second optical path 79 by, for example, a polarization splitter 81. The splitter 81 is configured to transmit one polarity and to reflect the other polarity. The first optical path 77 includes a first imager 83. The second optical path 79 includes an optional polarization rotator 85 (e.g. a 1/4 or 1/2 wave plate) and a second imager 87. If the rotator 85 is omitted, the second imager 87 must be re-oriented for the other polarity. The imagers 83, 87 are adapted to modulate the light thereon in accordance with the colored portions of the image and in synchronization with the rotation of the color wheel 76. In this example, the same signal is simultaneously provided to both imagers 83, 87 so that the same image corresponding to the same color is on the panels 83 and 87 at the same time.

The imagers 83, 87 may be reflective or transmissive devices including, for example, liquid crystal devices or digital micro-mirrors devices. Mirrors 89, 91 and/or other suitable optics are utilized to direct light along the respective optical paths 77, 79 and to direct the modulated light to a combiner 93. The merged image 95 is directed through a suitable lens system 97 onto, for example, a display screen. By utilizing both polarities, the amount of light throughputfor each color is effectively doubled.

If desired, instead of a single color wheel 76 for the entire system, separate color selectors (e.g. filters, shutters, or wheels) could be used for each path 77 and 79. For example, with a blue deficient source one path could correspond to blue at all times and the other path could be time sequenced between red and green.

Three Segment Color Wheel with Distributed White Segment

With reference to FIG. 8, some projection systems utilize a four segment color wheel having red (R), green (G), blue (B), and white (W) segments. The separate white section is used to improve brightness, but can lead to anomalous white intensity in the projected image. Also, the break in the RGB sequence may induce color breakup in the displayed image.

With reference to FIG. 9, a color wheel has three segments with a small amount of white bias in each segment. The primary red segment (Rgb) transmits red and a small amount of green and blue. The primary green segment (rGb) transmits green and a small amount of red and blue. The primary blue segment (rgB) transmits blue and a small amount of red and green. A light source which is sufficiently saturated in reds, greens, and blues can achieve comparable lumen throughput and maintain a suitable color gamut even with each primary color slightly diluted. Color breakup is reduced.

DMD System With Recycled OFF State Light

A mechanical mirror imager (e.g. a digital micro-mirror device—DMD) has two states where the mirrors are tilted to one side or the other of a tilt axis. These are typically +/−10 to 12 degrees of tilt. In an optical system, one tilt is considered an “ON” state and the other tilt is considered an “OFF” state. Light from the “ON” state is directed to a projection lens. Light from the “OFF” state is directed to an absorber, to preserve image contrast.

In accordance with a present aspect of the invention, “OFF” state light is re-directed back into the bulb where some portion of the “OFF” state light is absorbed and re-emitted as “ON” state light.

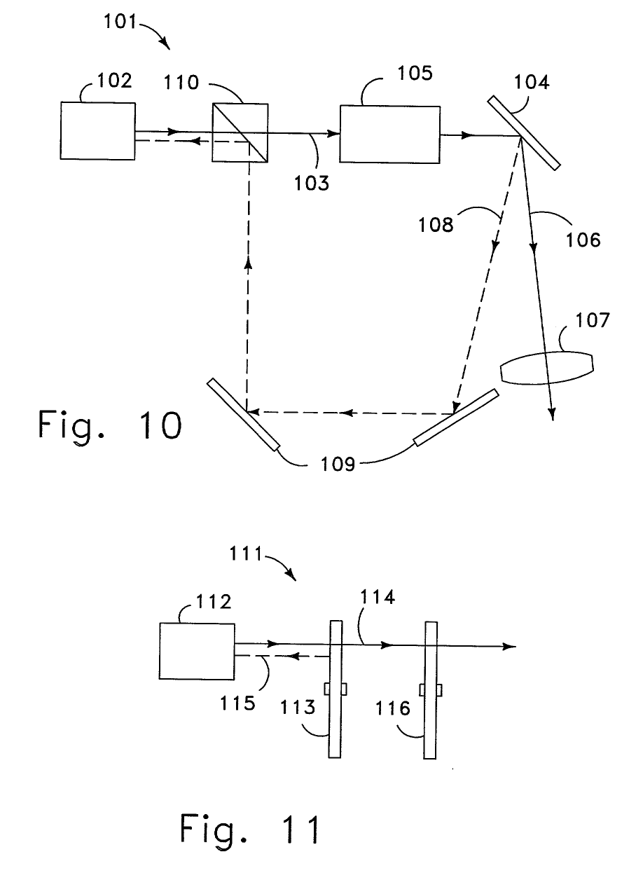

With reference to FIG. 10, a projection system 101 includes a lamp 102 which directs light along a path 103 towards a mechanical mirror imager 104 via suitable optics 105. ON state light 106 from the imager 104 is directed to a projection lens systems 107. OFF state light 108 is directed by mirrors 109 and/or other suitable optics 110 back to the lamp 102. With an appropriate fill, some of the re-directed OFF state light is re-emitted by the fill. The re-emitted light has a non-zero probability of becoming ON state light, thereby increasing the system efficiency.

Light Recycling With Dual Color Wheel System

A single color wheel positioned near a light source will reflect some of the light not passed through the color wheel back into the light source. With an appropriate light source, some fraction of the reflected light is absorbed and re-emitted at longer wavelengths. For example, blue light can be recycled into green, and green to red, but generally not the reverse. Thus, when the color wheel is transmitting blue light, it is not beneficial to reflect green and red light back into the lamp as this simply deposits heat into the structure without delivering more blue light.

According to a present aspect of the invention, a first color selector (e.g. a color shutter or a color wheel) selects light for reflection back into the bulb and a second color selector selects the portion of the transmitted light that will be injected into the projection train. Reflected light from the second reflector is not directed back to the bulb.

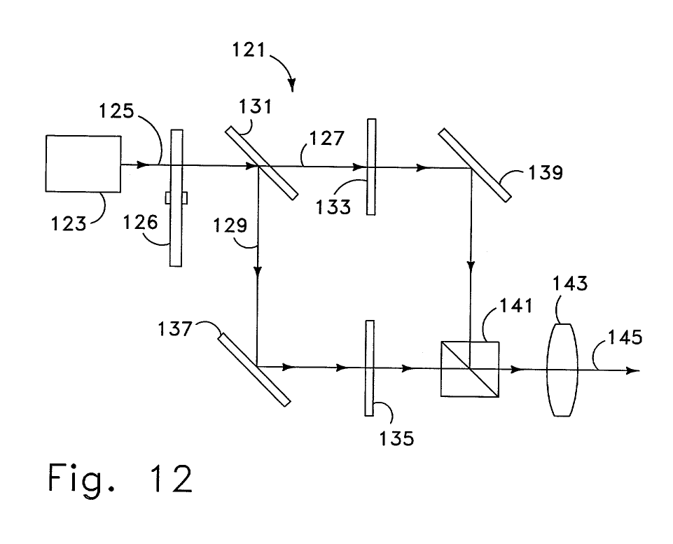

With reference to FIG. 11, a color selecting system 111 includes a lamp 112 directing light through a first color selector 113 along a path 114. Light which is not passed by the first color selector 113 is reflected back to the lamp 112 along a path 115. Light which is passed by the first color selector 113 is directed to a second color selector 116. Light which is passed by the second color selector 116 is directed through the projection train. Light which is not passed by the second color selector 116 is absorbed or otherwise not directed back to the lamp 112.

In a color wheel system, for example, during the blue image segment, the first wheel is clear (no light is reflected), and the second wheel passes blue and discards green and red. During the green image segment, the first wheel reflects blue and passes green and red, and the second wheel passes green and discards red. During the red segment, the first wheel reflects blue and green and passes red, and the second wheel is clear.

Color Recycling in a Two Panel Projection System

As noted above, two panel imaging systems can increase the light throughput compared to single panel systems. They can also effectively use a light source with a non-white color balance, being excessive or deficient in one of the primaries.

With reference to FIG. 12, a projection system 121 includes a lamp 123 which preferably provides full spectrum light. The light 125 from the lamp 123 is directed through a color selector 126 and split into a first optical path 127 and a second optical path 129 by, for example, a dichroic mirror 131. For example, the mirror 131 is configured to transmit red light and to reflect blue and green light. The first optical path 127 includes a first imager 133 which is adapted to modulate the light in accordance with the red portion of an image. The second optical path 129 includes a second imager 135. For example, one half of the color wheel 126 comprises a blue light filter and the other half of the color wheel 126 comprises a green light filter so that the light on the imager 135 is time sequenced between blue and green. Of course, other splits of blue and green (e.g. 60/40) may be used as desired. The imager 135 is adapted to modulate the light thereon in accordance with the blue and green portions of the image and in synchronization with the rotation of the color wheel 126.

Mirrors 137, 139 and/or other suitable optics are utilized to direct light along the respective optical paths 127,129 and to direct the modulated light to a combiner 141. The merged image 143 is directed through a suitable lens system 145 onto, for example, a display screen.

The imagers 133,135 may be reflective or transmissive devices including, for example, liquid crystal devices or digital micro-mirrors devices. Polarizing elements may also be included the optical paths 127, 129 as necessary. Prisms and/or other beam splitting optics may also be utilized as necessary or desirable.

In general, preferred light sources for the projection systems described herein are lamps of the type described in U.S. Pat. No. 6,137,237 and PCT Publication No. WO 01/03161, each of which is herein incorporated by reference in its entirety.

In accordance with the present aspect of the invention, a two panel system in a red deficient lamp system uses a color wheel such that either B+R or G+R are being transmitted, and subsequently a (B+G)/R splitter provides for spatial separation of the red light from the segmented blue and green light. The rejected blue light during the green segment is partially recycled into green light, while the rejected green light during the blue segment is partially recycled into red light.

Alternatively, a two panel system in a blue deficient lamp system uses a color wheel such that either B+G or B+R are being transmitted, and subsequently a B/(G+R) splitter provides for spatial separation of the blue light from the temporally segment green and red light. The rejected green light during the red segment is partially recycled into the red wavelength range. In this manner the blue light is always on one imager, while the green and red images timeshare the second imager. Further, using a reflecting selector allows for greater efficiency in the red.

While the invention has been described in connection with what is presently considered to be the preferred examples, it is to be understood that the invention is not limited to the disclosed examples, but on the contrary, is intended to cover various modifications and equivalent arrangements included within the spirit and scope of the inventions.

What is claimed is:

1. A projection system, comprising:
a light source; and
an optical system positioned to receive light from the source and to project light on a target,
characterized in that the optical system utilizes negative distortion and the light source has a shape which is pre-compensated in accordance with the negative distortion of the optical system.

2. The projection system as recited in claim 1, wherein the light source includes an aperture having the pre-compensated shape.

3. The projection system as recited in claim 2, wherein the target has a rectangular shape and the aperture has an inverted pin cushion shape.

4. A projection system, comprising:
a light source;
an imager; and
a single angle transforming optical element positioned between the light source and the imager.

5. The projection system as recited in claim 4, wherein:
the light source comprises an electrodeless aperture lamp providing relatively uniform light output;
the imager comprises one of a liquid crystal device or a digital micro-mirror device; and
the optical element consists of a compound parabolic concentrator configured to transform light from the angular distribution of the aperture lamp to the acceptance angle of the imager.

6. A projection system, comprising:
a light source;
a polarization splitter configured to receive light from the light source and to split the light into two polarities;
an optical system defining a first optical path and a second optical path, wherein light from the polarization splitter having one polarity is transmitted along the first optical path and light having the other polarity is transmitted along the second optical path;
a first imager aligned along the first optical path;
a second imager aligned along the second optical path; and
a combiner configured to merge the images from the first and second imagers.

7. A projection system, comprising:
a light source; and
a color wheel configured to sequentially filter light from the light source into different colors,
characterized in that each segment of the color wheel has a portion of white bias.

8. A projection system, comprising:
a light source which is capable of absorbing and re-emitting light directed back to the light source;
a digital micro-mirror device having a plurality of mirrors which tilt about respective axes, with different tilt angles of the mirrors corresponding to respective ON states and OFF states;
a first optical system arranged to receive light from the light source and direct the light to the digital micro-mirror device; and
a second optical system arranged to receive the OFF state light from the digital micro-mirror device and to direct the OFF state light back to the light source.

9. A projection system, comprising:
a light source which is capable of absorbing and re-emitting light directed back to the light source;
a first color selector positioned to receive light from the light source and to selectively transmit a portion of the light and to selectively reflect a portion of the light back to the light source; and
a second color selector positioned to receive the light transmitted from the first color selector and to selectively transmit a portion of the light.

10. The projection system as recited in claim 9, wherein light transmitted from the second color selector is time sequenced in a blue segment, a green segment, and a red segment, and wherein during the blue segment the first color selector is clear and the second color selector transmits blue light, during the green segment the first color selector reflects blue light and transmits red and green light and the second color selector transmits green light, and during the red segment the first color selector reflects blue and green light and transmits red light and the second color selector is clear.

11. A projection system, comprising:
a light source which is capable of absorbing and re-emitting light directed back to the light source, wherein the light is deficient in a color band;
a color selector which selectively transmits light and selectively reflects light back to the light source;
a color splitter configured to split the light into two components with one component corresponding to the deficient color band;
a first imager positioned to receive the light component corresponding to the deficient color band; and
a second imager positioned to receive the other components of light,
wherein the first imager operates in a continuous manner in accordance with the light component corresponding to the deficient color band and the second imager operates in a time sequenced manner in accordance with the other components of light.

12. The projection system as recited in claim 11, wherein the deficient color band corresponds to red light and wherein the color selector comprises a color wheel having a first segment which transmits blue and red light and a second segment which transmits green and red light, and wherein the first segment reflects green light back to the light source and the second segment reflects blue light back to the light source.
